(19) United States
(12) Patent Application Publication
(10) Pub. No.: US 2005/0261433 A1
(43) Pub. Date: Nov. 24, 2005

(54) Acrylic resin

(75) Inventors: Ryu Takeko, Ashiya-shi (JP); Akira Kawamura, Izumisano-shi (JP); Tomo Iwata, Niihama-shi (JP)

Correspondence Address: BIRCH STEWART KOLASCH & BIRCH, PO BOX 747, FALLS CHURCH, VA, 22040-0747, US

(73) Assignee: Sumitomo Chemical Company, Limited, Tokyo (JP)

(21) Appl. No.: 11/111,824

(22) Filed: Apr. 22, 2005

(30) Foreign Application Priority Data
Apr. 27, 2004 (JP) 2004-130759

(51) Int. Cl. C08F 8/00

(52) U.S. Cl. 525/222; 526/319

(57) ABSTRACT

An acrylic resin (1) containing a structural unit derived from the following monomer (a) (structural unit (a)), and a structural unit derived from the following monomer (b) (structural unit (b)):
(a): a (meth)acrylate of the formula (A) 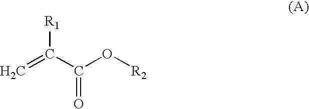
(wherein, R₁ represents a hydrogen atom or methyl group, R₂ represents an alkyl group having 1 to 14 carbon atoms or an aralkyl group having 1 to 14 carbon atoms, and a hydrogen atom in the alkyl group R₂ or a hydrogen atom in the aralkyl group R₂ may be substituted with an alkoxy group having 1 to 10 carbon atoms.), and (b): a monomer containing one olefinic double bond and at least one monomer containing an alicyclic structure in the molecule (the olefinic double bond contained in (b) may be contained in the alicyclic structure).

### BACKGROUND OF THE INVENTION

1. Technical Field of the invention

The present invention relates to an acrylic resin, and acrylic resin composition.

2. Description of the Related Art

Liquid crystal cells generally used in liquid crystal displays such as a TN liquid crystal cell (TFT), a STN liquid crystal cell (STN) and the like, have a structure in which a liquid crystal component is sandwiched between two glass base materials. On the surface of the glass base material, an optical film such as a polarizing film, phase retardation film and the like is laminated via an adhesive composed mainly of an acrylic resin. An optical laminate composed of a glass base material, adhesive and optical film laminated in this order is in general produced by a method in which first an optical laminated film having an adhesive layer composed of an adhesive laminated on an optical film is produced, subsequently, a glass base material is laminated on the surface of the adhesive layer.

Such an optical laminated film tends to generate curl and the like due to large dimension change by expansion and shrinkage under heating or moistening and heating conditions, consequently, there are problems such as occurrence of foaming in an adhesive layer of the resulted optical laminate, generation of peeling between an adhesive layer and a glass base material, and the like. Under heating or moistening and heating conditions, distribution of remaining stress acting on an optical laminated film becomes non-uniform, concentration of stress occurs around peripheral parts of an optical laminate, consequently, there is a problem that light leakage occurs in a TN liquid crystal cell (TFT). For solving such problems, there is a suggestion on an adhesive mainly composed of an acrylic resin having a structural unit derived from N-vinylpyrrolidone which is a kind of monomer having a hetero-cycle in the molecule (Japanese Patent Application Laid-Open (JP-A) No. 5-107410, Examples 1-4).

However, there is a problem that, when a liquid crystal cell obtained by using an optical laminate having an adhesive layer made of an adhesive mainly composed of an acrylic resin having a structural unit derived from N-vinylpyrrolidone is preserved under moistening and heating conditions, light leakage occurs and durability becomes worse.

### DISCLOSURE OF THE INVENTION

An object of the present invention is to provide an acrylic resin capable of producing an optical laminated film used in a liquid crystal cell in which light leakage is suppressed and durability is improved.

The present inventors have intensively studied to find an acrylic resin capable of solving problems as described above, and resultantly found that an acrylic resin having a kind of alicyclic structure manifests little light leakage and excellent in durability, when a liquid crystal cell is produced, and have completed the present invention.

Namely, the present invention provides the following [1] to [16].

[1] An acrylic resin (1) containing a structural unit derived from the following monomer (a) (structural unit (a)), and a structural unit derived from the following monomer (b) (structural unit (b)):
(a): a (meth)acrylate of the formula (A) 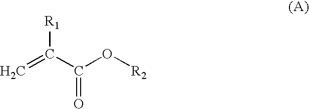
   (wherein, R₁ represents a hydrogen atom or methyl group, R₂ represents an alkyl group having 1 to 14 carbon atoms or an aralkyl group having 1 to 14 carbon atoms, and a hydrogen atom in the alkyl group R₂ or a hydrogen atom in the aralkyl group R₂ may be substituted with an alkoxy group having 1 to 10 carbon atoms.), and
(b): a monomer containing one olefinic double bond and at least one monomer containing an alicyclic structure in the molecule (the olefinic double bond contained in (b) may be contained in the alicyclic structure).

[2] The acrylic resin (1) according to [1], wherein the content of the structural unit (a) is from 65 to 99.9 parts by weight based on 100 parts by weight of acrylic resin (1).

[3] The acrylic resin (1) according to [1] or [2] wherein the content of the structural unit (b) is from 0.1 to 30 parts by weight based on 100 parts by weight of acrylic resin (1).

[4] The acrylic resin (1) according to any one of [1]-[3], wherein the structural unit (b) is a structural unit derived from isobornyl acrylate and/or cyclohexyl acrylate.

[5] The acrylic resin (1) according to any one of [1]-[4] further containing a structural unit derived from the following monomer (c) (structural unit (c)):
(c): a monomer different from the above-mentioned monomers (a) and (b), and containing one olefinic double bond and at least one polar functional group selected from the group consisting of a carboxyl group, hydroxyl group, amide group, amino group, epoxy group, aldehyde group and isocyanate group in the molecule.

[6] An acrylic resin composition containing acrylic resin (1) according to [1]-[5] and the following acrylic resin (2):
acrylic resin (2): acrylic resin containing above-mentioned structural unit (a) and containing substantially no above-mentioned structural unit (b).

[7] The acrylic resin composition according to [6] further containing a structural unit derived from above-mentioned monomer (c) (structural unit (c)).

[8] The acrylic resin composition according to [6] or [7], wherein the content of the acrylic resin having lower molecular weight between acrylic resin (1) and acrylic resin (2) is from 5 to 50 parts by weight based on 100 parts by weight of the total amount of acrylic resin (1) and acrylic resin (2).

[9] An adhesive comprising the acrylic resin (1) according to any one of [1]-[5] or the acrylic resin composition according to any one of [6]-[8], and a cross-linking agent and/or silane-based compound.

[10] An optical laminated film obtained by laminating an adhesive layer composed of the adhesive according to [9] on both surfaces or one surface of an optical film.

[11] The optical laminated film according to [10], wherein the optical film is a polarizing film and/or phase retardation film.

[12] The optical laminated film according to [10] or [11], wherein the optical film is an optical film further having an acetylcellulose-based film as a protective film.

[13] The optical laminated film according to any of [10] to [12,], wherein a release film is further laminated on the adhesive layer of the optical laminated film.

[14] An optical laminate obtained by laminating a glass base material on the adhesive layer of the optical laminated film according to any of [10] to [13].

[15] An optical laminate obtained by peeling the release film from the optical laminated film according to [14], then, laminating a glass base material on the resulted adhesive layer of the optical laminated film.

[16] An optical laminate obtained by peeling the optical laminated film from the optical laminated according to [14] or [15], then, laminating again the optical laminated film on the resulted glass base material.

The present invention will be described in detail below.

The monomer (a) used in the present invention is a (meth)acrylate of the formula (A): 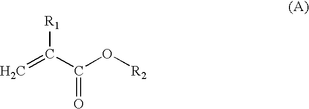
wherein, R₁ represents a hydrogen atom or methyl group, and R₂ represents an alkyl group having 1 to 14 carbon atoms or an aralkyl group having 1 to 14 carbon atoms, and a hydrogen atom in the alkyl group R₂ or a hydrogen atom in the aralkyl group R₂ may be substituted with an alkoxy group having 1 to 10 carbon atoms.

Examples of the alkyl group having 1 to 14 carbon atoms include a methyl group, ethyl group, butyl group, octyl group and the like.

Examples of the aralkyl group having 1 to 14 carbon atoms include a benzyl group and the like.

Examples of the alkoxy group having 1 to 10 carbon atoms include a methoxy group, ethoxy group, butoxy group and the like.

Examples of the monomer (a) include acrylates such as methyl acrylate, ethyl acrylate, propyl acrylate, n-butyl acrylate, iso-butyl acrylate, t-butyl acrylate, 2-ethylhexyl acrylate, n-octyl acrylate, iso-octyl acrylate, lauryl acrylate, stearyl acrylate, benzyl acrylate, methoxyethyl acrylate and ethoxylmethyl acrylate and the like; and methacrylates such as methyl methacrylate, ethyl methacrylate, propyl methacrylate, n-butyl methacrylate, iso-butyl methacrylate, t-butyl methacrylate, 2-ethylhexyl methacrylate, n-octyl methacrylate, iso-octyl methacrylate, lauryl methacrylate, stearyl methacrylate, benzyl methacrylate, methoxyethyl methacrylate, ethoxymethyl methacrylate and the like.

The monomer (a) is used alone or in admixture of two or more.

The content of a structural unit derived from the monomer (a) (structural unit (a)) contained in acrylic resin (1) is usually from approximately 65 to 99.9 parts by weight, preferably from approximately 80 to 99.7 parts by weight based on 100 parts by weight of an acrylic resin (1).

The monomer (b) used in the acrylic resin (1) of the present invention is a monomer containing one olefinic double bond and at least one monomer containing an alicyclic structure in the molecule. The olefinic double bond contained in the monomer (b) may be contained in the alicyclic structure.

Here, alicyclic structure means cycloparaffin structure or cycloolefin structure. In case of cycloolefin structure, olefinic double bond is contained in alicyclic structure.

The monomer (b) is used alone or in admixture of two or more.

Specific examples of the monomer (b) include acrylate having alicyclic structure such as isobornyl acrylate, cyclohexyl acrylate, dicyclopentanyl acrylate, cyclododecyl acrylate, methyl cyclohexyl acrylate, trimethyl cyclohexyl acrylate, tert-butyl cyclohexyl acrylate, cyclohexyl α-ethoxy acrylate, cyclohexyl phenyl acrylate, and the like; methacrylate having alicyclic structure such as isobornyl methacrylate, cyclohexyl methacrylate, dicyclopentanyl methacrylate, cyclododecyl methacrylate, methyl cyclohexyl methacrylate, trimethyl cyclohexyl methacrylate, tert-butyl cyclohexyl methacrylate, cyclohexyl α-ethoxy methacrylate, cyclohexyl phenyl methacrylate, and the like.

Examples of the other type of the monomer (b) include biscyclohexyl methyl itaconate, dicyclooctyl itaconate, dicyclododecyl methyl succinate, vinyl cyclohexyl acetate, and the like.

As the monomer (b), isobornyl acrylate, cyclohexyl acrylate, isobornyl methacrylate, cyclohexyl methacrylate, dicyclopentanyl acrylate are preferably used because they can be easily obtained.

The content of a structural unit derived from the monomer (b) (structural unit (b)) contained in the acrylic resin (1) is usually from approximately 0.1 to 30 parts by weight, preferably from approximately 0.3 to 15 parts by weight based on 100 parts by weight of the acrylic resin (1). When the content of the structural unit (b) is 0.1 part by weight or more, peeling between an adhesive layer and a glass base material in processing a liquid crystal panel tend to be improved preferably. When the content of a structural unit (b) is 30 parts by weight or less, peeling between a glass base material and an adhesive layer tends to be suppressed preferably.

In the acrylic resin (1), a structural unit (c) derived from the monomer (c) may be contained. The structural unit (c) is different from (a) and (b), and contains one olefinic double bond in the molecule and at least one polar functional group selected from the group consisting of a carboxyl group, hydroxyl group, amino group, amide group, epoxy group, aldehyde group and isocyanate group.

Examples of the monomer (c) in which the polar functional group is a carboxyl group include α,β-unsaturated carboxylic acids such as acrylic acid, methacrylic acid, maleic acid, itaconic acid and the like;
in which the polar functional group is a hydroxyl group include hydroxyalkyl α,β-unsaturated carboxylates such as 2-hydroxyethyl (meth)acrylate, 2-hydroxypropyl (meth)acrylate, 4-hydroxybutyl (meth)acrylate and the like;
in which the polar functional group is an amino group include N,N-dimethylaminoethyl acrylate, allylamine and the like;
in which the polar functional group is an amide group include acrylamide, methacrylamide, N,N-dimethylaminopropylacrylamide, diacetonediamide, N,N-dimethylacrylamide, N,N-diethylacrylamide, N-methylolacrylamide and the like;
in which the polar functional group is an epoxy group include glycidyl acrylate, glycidyl methacrylate and the like;
in which the polar functional group is an aldehyde group include acrylaldehyde and the like;
in which the polar functional group is an isocyanate group include 2-methacryloyloxyethyl isocyanate and the like.

The monomer (c) may be used alone or in admixture of two or more.

Among them, α,β-unsaturated carboxylic acids and hydroxyalkyl α,β-unsaturated carboxylates are preferably used as the monomer (c), and more preferably used are acrylic acid, methacrylic acid, 2-hydroxyethyl (meth)acrylate, 2-hydroxypropyl (meth)acrylate and 4-hydroxybutyl (meth)acrylate, and further preferably used are 2-hydroxyethyl (meth)acrylate, 2-hydroxypropyl (meth)acrylate and 4-hydroxybutyl (meth)acrylate.

The content of a structural unit derived from the monomer (c) contained in the acrylic resin (1) is usually from approximately 0.05 to 20 parts by weight, preferably from approximately 0.1 to 15 parts by weight based on 100 parts by weight of the acrylic resin (1). When the content of the structural unit (c) is 0.05 parts by weight or more, cohesive force of the resulting resin tends to be improved preferably, and when 20 parts by weight or less, peeling between an adhesive layer and an optical film tends to be suppressed preferably.

In producing the acrylic resin (1) used in the present invention, the monomers (a) to (c) may be copolymerized with a vinyl-based monomer (d) different from any of the monomers (a) to (c).

Examples of the vinyl-based monomer (d) include fatty vinyl esters, halogenated vinyls, halogenated vinylidenes, aromatic vinyls, (meth)acrylonitrile, conjugated diene compounds and the like.

Examples of the fatty vinyl ester include vinyl acetate, vinyl propionate, vinyl butyrate, vinyl 2-ethylhexanoate, vinyl laurate and the like.

Examples of the halogenated vinyl include vinyl chloride, vinyl bromide and the like.

Examples of the halogenated vinylidene include vinylidene chloride and the like.

The aromatic vinyl is a compound having a vinyl group and an aromatic group, and specific examples thereof include styrene-based monomers such as styrene, methylstyrene, dimethylstyrene, trimethylstyrene, ethylstyrene, diethylstyrene, triethylstyrene, propylstyrene, butylstyrene, hexylstyrene, heptylstyrene, octylstyrene, fluorostyrene, chlorostyrene, bromostyrene, dibromostyrene, iodostyrene, nitrostyrene, acetylstyrene, methoxystyrene, cyclohexylstyrene and the like; nitrogen-containing aromatic vinyls such as vinylpyridine, vinylpyrolidone, vinylcaprolactam, vinyl carbazole and the like.

Examples of the (meth)acrylonitrile include acrylonitrile, methacrylonitrile and the like.

The conjugated diene compound is an olefin containing a conjugated double bond in the molecule, and specific examples thereof include isoprene, butadiene, chloroprene and the like.

These vinyl-based monomer (d) may be used alone or in admixture of two or more.

An acrylic resin composition of the present invention contains the above-mentioned acrylic resin (1) and the following acrylic resin (2).
acrylic resin (2): acrylic resin containing above-mentioned structural unit (a) and containing substantially no above-mentioned structural unit (b).

The content of structural unit (a) contained in acrylic resin (2) is usually from approximately 65 parts by weight or more, preferably from approximately 75 to 99.9 parts by weight based on 100 parts by weight of an acrylic resin (2).

In the acrylic resin (2), a structural unit derived from the above-mentioned monomer (c) and/or (d) is/are further contained preferably, a structural unit (c) is contained more preferably.

The content of a structural unit (c) contained in the acrylic resin (2) is usually from approximately 0.05 to 20 parts by weight, preferably from approximately 0.1 to 15 parts by weight based on 100 parts by weight of the acrylic resin (2). When the content of the structural unit (c) is 0.05 parts by weight or more, cohesive force of the resulting resin tends to be improved preferably, and when 20 parts by weight or less, even if the dimension of an optical film changes, the resulting adhesive layer varies following this dimension change, consequently, a difference between brightness of peripheral parts of a liquid crystal cell and brightness of central parts disappears, and light leakage and non-uniformity of color tend to be suppressed preferably.

As the method of producing an acrylic resin (1) and (2) used in the present invention, for example, a solution polymerization method, emulsion polymerization method, bulk polymerization method, suspension polymerization method and the like are listed.

In production of an acrylic resin, a polymerization initiator is usually used. The polymerization initiator is used in an amount of approximately 0.001 to 5 parts by weight based on 100 parts by weight of the total weight of the monomers used in producing the acrylic resin.

As the polymerization initiator, photo-polymerization initiator, a heat-polymerization initiator and the like are exemplified.

Examples of the photo-polymerization initiator include 4-(2-hydroxyethoxy)phenyl(2-hydroxy-2-propyl)ketone and the like.

Examples of the heat-polymerization initiator include azo-based compounds such as 2,2′-azobisisobutyronitrile, 2,2′-azobis(2-methylbutyronitrile), 1,1′-azobis(cyclohexane-1-carbonitrile), 2,2′-azobis(2,4-dimethylvaleronitrile), 2,2′-azobis(2,4-dimethyl-4-methoxyvaletonitrile), dimethyl-2,2′-azobis(2-methyl propionate), 2,2′-azobis(2-hydroxymethylpropionitrile) and the like; organic peroxides such as lauryl peroxide, tert-butyl hydroperoxide, benzoyl peroxide, tert-butyl peroxybenzoate, cumene hydroperoxide, diisopropyl peroxydicarbonate, di-n-propyl peroxydicarbonate, tert-butyl peroxyneodecanoate, tert-butyl peroxypivalate, (3,5,5-trimethylhexanonyl) peroxide and the like; inorganic peroxides such as potassium persulfate, ammonium persulfate, hydrogen peroxide and the like.

Further, redox-based initiators using a heat-polymerization initiator and a reducing agent together can also be used as a polymerization initiator.

As the method of producing an acrylic resin of the present invention, a solution polymerization method is preferable.

As a specific example of a solution polymerization method, there are listed, for example, a method in which the desired monomers such as monomers (a) to (d) etc. and an organic solvent are mixed, a heat-polymerization initiator is added under a nitrogen atmosphere and the mixture is stirred for approximately 3 to 12 hours at usually approximately 40 to 90° C., preferably approximately 60 to 80° C., and other methods. The reaction may also be controlled by a method in which monomers and a heat-polymerization initiator used are added as it is during the polymerization reaction, a method in which monomers and a heat-polymerization initiator used are dissolved in an organic solvent before addition thereof, and the like.

Here, examples of the organic solvent used include aromatic hydrocarbons such as toluene, xylene and the like; esters such as ethyl acetate, butyl acetate and the like; aliphatic alcohols such as n-propyl alcohol, isopropyl alcohol and the like; ketones such as methyl ethyl ketone, methyl isobutyl ketone and the like.

When using the acrylic resin (1) alone, the weight-average molecular weight of the acrylic resin (1) according to polystyrene calibration standard method of gel permeation chromatography (GPC) is preferably 70×10⁴ to 180×10⁴, more preferably 100×10⁴ to 150×10⁴. When the weight-average molecular weight is 70×10⁴ or more, adhesion under high temperature and high humidity increases, and peeling between an adhesive layer and a glass base plate tends to lower, further, a re-working property tends to be improved, preferably. When the weight-average molecular weight is 180×10⁴ or less, even if the dimension of an optical film changes, the resulting adhesive layer varies following this dimension change, consequently, a difference between brightness of peripheral parts of a liquid crystal cell and brightness of central parts disappears, and light leakage and non-uniformity of color tend to be suppressed preferably.

When using the acrylic resin composition containing the acrylic resin (1) and the acrylic resin (2), the weight-average molecular weight of the acrylic resin having higher weight-average molecular weight according to polystyrene calibration standard method of gel permeation chromatography (GPC) is preferably 70×10⁴ to 180×10⁴, more preferably 100×10⁴ to 150×10⁴. When the weight-average molecular weight is 76×10⁴ or more, adhesion under high temperature and high humidity increases, and peeling between an adhesive layer and a glass base plate tends to lower, further, a re-working property tends to be improved, preferably. When the weight-average molecular weight is 180×10⁴ or less, even if the dimension of an optical film changes, the resulting adhesive layer varies following this dimension change, consequently, a difference between brightness of peripheral parts of a liquid crystal cell and brightness of central parts disappears, and light leakage and non-uniformity of color tend to be suppressed preferably.

The acrylic resin having lower weight-average molecular weight according to polystyrene calibration standard method of gel permeation chromatography (GPC) is preferably 5×10⁴ to 45×10⁴, more preferably 5×10⁴ to 30×10⁴. When the weight-average molecular weight is 5×10⁴ or more, adhesion under high temperature and high humidity increases, and peeling between an adhesive layer and a glass base plate tends to lower, further, a re-working property tends to be improved, preferably. When the weight-average molecular weight is 45×10⁴ or less, even if the dimension of an optical film changes, the resulting adhesive layer varies following this dimension change, consequently, a difference between brightness of peripheral parts of a liquid crystal cell and brightness of central parts disappears, and light leakage and non-uniformity of color tend to be suppressed preferably.

The viscosity at 25° C. of the solution prepared containing 25% by weight of non-volatile component of the acrylic resin (1) or (2) in ethyl acetate is usually 20 Pa·s or less, preferably 1 to 10 Pa·s. When the viscosity of the acrylic resin is 20 Pa·s or less, adhesion under high temperature and high humidity increases, and peeling between an adhesive layer and a glass base plate tends to lower, further, a re-working property tends to be improved, preferably.

As the production method of the acrylic resin composition of the present invention, usually, an acrylic resin (1) and acrylic resin (2) are separately produced, and then, mixed, or, it may also be permissible that either an acrylic resin (1) or acrylic resin (2) is produced, then, another acrylic resin is produced in the presence of the produced acrylic resin. Further, it may also be permissible that acrylic resins (1) and (2) are mixed, and then, diluted with an organic solvent.

As the weight ratio (non-volatile component) in the acrylic resin composition, the ratio of the acrylic resin having lower molecular weight between the acrylic resin (1) and the acrylic resin (2) is usually 50 parts by weight or less, preferably approximately 5 to 50 parts by weight based on 100 parts by weight of the total amount of the acrylic resin (1) and acrylic resin (2). When the ratio of the acrylic resin having lower molecular weight is 5 parts by weight or more, even if the dimension of an optical film changes, an adhesive layer varies following this dimension change, consequently, a difference between brightness of peripheral parts of a liquid crystal cell and brightness of central parts disappear (becomes smaller), and light leakage and non-uniformity of color tend to be suppressed preferably. When the ratio of the acrylic resin having lower molecular weight is 50 parts by weight or less, cohesive force of the resulting resin tends to be improved and foaming under high temperature and high humidity tend to be suppressed preferably.

The acrylic resin composition of the present invention may be used as it is, for example as an adhesive, paint, thickening agent and the like.

Of them, an adhesive obtained by compounding a cross-linking agent and/or silane-based compound with the acrylic resin (1) alone or the acrylic resin composition of the present invention is preferable since it is excellent in durability and adhesion to an optical film and the like, and particularly, an adhesive obtained by compounding a cross-linking agent and silane-based compound with the acrylic resin (1) or the acrylic resin composition of the present invention is suitably used.

Here, the cross-linking agent has in the molecule two or more functional groups capable of cross-linking with a polar functional group, and specific examples thereof include isocyanate-based compounds, epoxy-based compounds, aziridine-based compounds and the like.

Here, examples of the isocyanate-based compound include tolylene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, tetramethylxylylene diisocyanate, naphthalene diisocyanate, triphenylmethane triisocyanate, polymethylene polyphenyl isocyanate and the like. Further, adducts obtained by reacting polyols such as glycerol, trimethylolpropane and the like with the above-mentioned isocyanate compounds, dimmer or trimer of the above-mentioned isocyanate compounds can also be used.

Examples of the epoxy-based compound include bisphenol A type epoxy resin, ethylene glycol glycidyl ether, polyethylene glycol diglycidyl ether, glycerine diglycidyl ether, glycerine triglycidyl ether, 1,6-hexanediol diglycidyl ether, trimethylolpropane triglycidyl ether, diglycidylaniline, N,N,N′,N′-tetraglycidyl-m-xylenediamine, 1,3-bis(N,N′-diglycidylaminomethyl)cyclohexane and the like.

Examples of the aziridine-based compound include N,N′-diphenylmethane-4,4′-bis(1-aziridine carboxide), N,N′-toluene-2,4-bis(1-aziridine carboxamide), triethylenemelamine, bisisophthaloyl-1-(2-methylaziridine), tri-1-aziridinylphosphine oxide, N,N′-hexamethylene-1,6-bis(1-aziridine carboxide), trimethylolpropane-tri-β-aziridinyl propionate, tetramethylolmethane-tri-β-aziridinyl propionate, and the like.

In the adhesive of the present invention, two or more of cross-linking agents may be used.

The use amount of a cross-linking (non-volatile component) in the adhesive of the present invention is usually from approximately 0.005 to 5 parts by weight, preferably from approximately 0.01 to 3 parts by weight based on 100 parts by weight of the acrylic resin (1) or the acrylic resin composition (non-volatile component). When the amount of the cross-linking agent is 0.005 parts by weight or more, peeling between an adhesive layer and an optical film and a re-working property tend to be improved preferably, and when 5 parts by weight or less, a property of an adhesive layer to follow the dimension change of an optical film is excellent, consequently, light leakage and non-uniformity of color tend to lower, preferably.

Examples of the silane-based compound used in the adhesive of the present invention include vinyltrimethoxysilane, vinyltriethoxysilane, vinyltris(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidoxypropyltrimethoxysilane, 3-glycidoxypropylmethyldimethoxysilane, 2-(3,4-epoxycyclohexyl)ethyltrimethoxysilane, 3-chloropropylmethyldimethoxysilane, 3-chloropropyltrimethoxysilane, 3-methacryloxypropyltrimethoxysilane, 3-mercaptopropyltrimethoxysilane and the like. The silane-based compound may be used singly or in admixture of two or more.

The use amount of the silane-based compound in the adhesive is usually from approximately 0.0001 to 10 parts by weight, preferably from 0.01 to 5 parts by weight based on 100 parts by weight of the acrylic resin (1) or the acrylic resin composition. When the amount of a silane-based compound is 0.0001 part by weight or more, adhesion between an adhesive layer and a glass base plate is improved preferably. When the amount of a silane-based compound is 10 parts by weight or less, bleeding out of a silane-based compound from the adhesive layer tends to be suppressed to suppress cohesive failure of an adhesive layer, preferably.

The adhesive can be produced in comparatively short time by compounding a catalyst together with a cross-linking agent.

Examples of the catalyst include amine-based compound, metal chelate compound, and the like.

Examples of amine-based compound include hexamethylenediamine, ethylenediamine, polyethyleneimine, hexamethylenetetramine, diethylenetriamine, triethylenetetramine, isophoronediamine, triethylenediamine, polyamino resin, melamine resin, and the like.

Examples of metal chelate compound include compounds obtained by coordinating acetylacetone or ethyl acetoacetate on poly-valent metals such as aluminum, iron, copper, zinc, tin, titanium, nickel, antimony, magnesium, vanadium, chromium, zirconium and the like.

The adhesive of the present invention may further contain weather-resistant stabilizer, tackifier, plasticizer, softing agent, dye, pigment, inorganic filler, and the like, in addition to above-mentioned catalyst.

The optical laminated film of the present invention is obtained by laminating the above-mentioned adhesive on both surfaces or one surface of an optical film.

Here, the optical film used is a film having an optical property, and examples thereof include a polarizing film, phase retardation film and the like.

The polarizing film is an optical film having a function of emitting polarization against incidence light such as natural light and the like.

Examples of the polarizing film include a straight line polarizing film absorbing straight line polarization on a vibration plane parallel to an optical axis and allowing permeation of straight light polarization having a vibration plane which is a vertical plane; a polarization separation film reflecting straight line polarization on a vibration plane parallel to an optical axis; an elliptic polarizing film obtained by laminating a polarizing film and a phase retardation film described later, and the like. As the specific examples of the polarizing film, those in which dichroic coloring matters such as iodine, dichroic dyes and the like are adsorbed and oriented in a polyvinyl alcohol film mono-axially stretched, and the like are listed.

The phase retardation film used is an optical film having mono-axial or di-axial optical anisotropy.

Examples of the phase retardation film include stretched films obtained by stretching at approximately 1.01 to 6-fold a polymer film made of polyvinyl alcohol, polycarbonate, polyester, polyallylate, polyimide, polyolefin, polystyrene, polysulfone, polyether sulfone, polyvinylidene fluoride/polymethyl methacrylate, liquid crystal polyester, acetylcellulose, cyclic polyolefin, ethylene-vinyl acetate copolymer saponified material, polyvinyl chloride and the like. Of them, polymer films obtained by mono-axial or bi-axial stretching of polycarbonate or polyvinyl alcohol are preferably used.

Examples of the phase retardation film include a mono-axial phase retardation film, wide field angle phase retardation film, low photo-elastic phase retardation film, temperature-compensated phase retardation film, LC film (rod-like liquid crystal twisted orientation), WV film (disc-like liquid crystal inclined orientation), NH film (rod-like liquid crystal inclined orientation), VAC film (complete bi-axial orientation type phase retardation film), new VAC film (bi-axial orientation type phase retardation film) and the like.

Further, in the present invention, a film obtained by pasting a protective film to these optical films may be used as an optical film and can be laminated to the adhesive of the present invention.

Here, examples of the protective film include acrylic resin films made of acrylic resins different from the acrylic resin of the present invention; acetylcellulose-based films such as a cellulose tiacetate film and the like; polyester resin films; olefin resin films; polycarbonate resin films; polyether ether ketone resin films; polysulfone resin films and the like.

In the protective film, ultraviolet absorbers such as a salicylate-based compound, benzophenone-based compound, benzotriazole-based compound, triazine-based compound, cyanoacrylate-based compound, nickel complex salt-based compound and the like may be compounded. Among these protective films, acetylcellulosed-based films are suitably used.

The optical laminate of the present invention is obtained by laminating a glass base material on an adhesive layer of an optical laminated film.

Here, examples of the glass base material include a glass base plate of liquid crystal cell, non-glaring glass, glass for sunglasses, and the like. Among them, an optical laminate obtained by laminating an optical laminated film (upper plate polarization plate) on an upper glass base plate of a liquid crystal cell, and laminating another optical laminated film (lower plate polarization plate) on a lower glass base plate of a liquid crystal cell is preferable since it can be used as a liquid crystal display. As the material of a glass base material, for example, soda lime glass, low-alkali glass, non-alkali glass and the like are listed.

As the method for producing an optical laminated film and an optical laminate, there are listed, for example, a method in which an adhesive is laminated on a release film, an optical film is further laminated on the resulted adhesive layer, then, the release film is peeled to obtain an optical laminated film, subsequently, the adhesive layer and a surface of a glass base plate are laminated to produce an optical laminate; a method in which an adhesive is laminated on an optical film, and a release film is applied to produce a protected optical laminated film, and in lamination on a surface of a glass base plate, the release film is peeled from the optical laminated film, and the adhesive layer and a surface of a glass base plate are laminated to produce an optical laminate; and the like.

Here, as the release film, there are mentioned, for example, those obtained by using, as a base material, a film composed of various resins such as polyethylene terephthalate, polybutylene terephthalate, polycarbonate, polyallylate and the like, and performing releasing treatment (silicone treatment and the like) on a surface to be connected to an adhesive layer of this base material.

The present invention can provide an acrylic resin capable of producing an optical laminated film used in a liquid crystal cell in which light leakage is suppressed and durability is improved.

The acrylic resin or the acrylic resin composition of the present invention can provide an adhesive having excellent durability and strong adhesion to an optical film. A composition containing the acrylic resin composition and a cross-linking agent and/or silane-based compound can be suitably used as an adhesive. An optical laminated film obtained by laminating an optical film and the adhesive can be, for example, laminated on a glass base plate of a liquid crystal cell to produce the optical laminate of the present invention. The optical laminate has durability for a stress derived from the dimension change of the optical film and glass base plate under heat and humidity conditions, therefore, peeling of the adhesive layer from the glass base plate is suppressed. Further, since optical defects caused by un-uniform stress distribution are prevented, when the glass base plate is a TN liquid crystal cell (TNT), light leakage is suppressed, and when the glass base plate is a STN liquid crystal cell, non-uniformity of color is suppressed. Furthermore, since a re-working property is excellent, even if an optical laminated film once laminated is peeled from the glass base plate of the optical laminate, paste remaining and fogging on the surface of the glass base plate after peeling are suppressed.

The acrylic resin of the present invention can be used for, for example, an adhesive, paint, thickening agent and the like. The adhesive of the present invention can be used suitably in optical laminates such as a liquid crystal cell and the like.

### EXAMPLES

The present invention will be described further in detail based on examples, but it is needless to say that the scope of the invention is not limited to these examples at all.

In the examples, “parts” and “%” are by weight unless otherwise stated.

The content of non-volatile components was measured according to a method of JIS K-5407. Specifically, an optional weight of adhesive solution was placed on a Petri dish, and dried in an explosion protection oven at 115° C. for 2 hours, then, the weight of remaining non-volatile components was divided by the weight of the originally weighed solution.

The viscosity is a value measured by a Brook field viscometer at 25° C.

Measurement of the weight-average molecular weight by a GPC was conducted using a GPC apparatus equipped with a differential refractometer as a detector, under conditions of a sample concentration of 5 mg/ml, a sample introduction amount of 100 μl, a column temperature of 40° C. and a flow rate of 1 ml/min, and using tetrahydrofuran as an eluent.

Measurement of the weight-average molecular weight based on polystyrene calibration standard was conducted by measuring a sample and standard polystyrene under the same GPC conditions and converting the molecular weight by using retention time.

<Production Example of Acrylic Resin>

### Polymerization Example 1

Into a reactor equipped with a cooling tube, nitrogen introduction tube, thermometer and stirrer was charged 100 parts of ethyl acetate, 97.8 parts of butyl acrylate as a monomer (a), 1.6 parts of isobornyl acrylate as a monomer (b) and 0.6 part of acrylic acid as a monomer (c), and air in the apparatus was purged with a nitrogen gas (substantially no oxygen contained in the apparatus), then, the inner temperature was raised to 70° C. A solution prepared by dissolving 0.03 part of azobisisobutyronitrile (hereinafter, referred to as AIBN) in 10 parts of ethyl acetate was added to the reactor, while keeping the inner temperature at 69 to 71° C. for 12 hours, to complete the reaction. A weight-average molecular weight based on polystyrene calibration standard was 1520000.

### Polymerization Example 2

The reaction was completed in the same manner as in Polymerization Example 1 except that parts of monomer (a), (b), (c) and (d) used were as illustrated in Table 1. The results are illustrated in Table 1.

### Polymerization Example 3

Into a reactor equipped with a cooling tube, nitrogen introduction tube, thermometer and stirrer was charged 222 parts of ethyl acetate, and air in the apparatus was purged with a nitrogen gas (substantially no oxygen contained in the apparatus), then the inner temperature was raised to 75° C. A solution prepared by dissolving 0.55 part of azobisisobutyronitrile (hereinafter, referred to as AIBN) in 12.5 parts of ethyl acetate was added to the reactor while keeping the inner temperature at 69 to 71° C., then, a mixed solution of 92.2 parts of butyl acrylate as a monomer (a) and 7.8 parts of isobornyl acrylate as a monomer (b) was dropped into the reactor over 3 hours. Thereafter, the mixture was thermally insulted at 69 to 71° C. for 5 hours, to complete the reaction. The results are illustrated in Table 1.

### Polymerization Example 4

The reaction was completed in the same manner as in Polymerization Example 1 except that parts of monomer (a) and (b) used were as illustrated in Table 1. The results are illustrated in Table 1.

### Polymerization Example 5

The reaction was completed in the same manner as in Polymerization Example 1 except that 46.8 parts of butyl acrylate, 33.1 parts of butyl methacrylate and 6.7 parts of methyl acrylate as a monomer (a), 4.8 parts of isobornyl acrylate as a monomer (b), and 8.6 parts of N-vinylpyrrolidone as a monomer (d) were used. The results are illustrated in Table 1.

### Polymerization Example 6

The reaction was completed in the same manner as in Polymerization Example 1 except that 94.0 parts of butyl acrylate as a monomer (a) and 6.0 parts of cyclohexyl acrylate as a monomer (b) were used. The results are illustrated in Table 1.

### Polymerization Example 7

The reaction was completed in the same manner as in Polymerization Example 1 except that 99.4 parts of butyl acrylate as a monomer (a) and 0.6 part of acrylic acid as a monomer (c) were used, and monomer (b) was not used. The results are illustrated in Table 1.

### Polymerization Example 8

The reaction was completed in the same manner as in Polymerization Example 7 except that 98.9 parts of butyl acrylate as a monomer (a) and 1.1 parts of 4-hydroxybutyl acrylate as a monomer (c) were used. The results are illustrated in Table 1.

### Polymerization Example 9

The reaction was completed in the same manner as in Polymerization Example 1 except that 93.7 parts of butyl acrylate_and 2.0 parts of 4-hydroxybutyl acrylate as a monomer (c) were used, and monomer (b) was not used and 4.3 parts of N-vinylpyrrolidone, having a hetero ring, as a monomer (d) was used. The results are illustrated in Table 1.

### Polymerization Example 10

The reaction was completed in the same manner as in Polymerization Example 3 except that 99.4 parts of butyl acrylate as a monomer (a) and 0.6 part of acrylic acid as a monomer (c) were used, and monomer (b) was not used. The results are illustrated in Table 1.

TABLE 1

| | | | | | Weight-average |
|---|---|---|---|---|---|
| Polymerization | (a)*¹ | (b)*¹ | (c)*¹ | (d)*¹ | molecular |
| Example | (parts) | (parts) | (parts) | (parts) | weight (×10³) |
| 1 | 97.8 | 1.6 | 0.6 | 0 | 1,520 |
| 2 | 91.6 | 7.8 | 0.6 | 0 | 1,450 |
| 3 | 92.2 | 7.8 | 0 | 0 | 124 |
| 4 | 78 | 22 | 0 | 0 | 114 |
| 5 | 87.6 | 4.8 | 0 | 8.6*² | 114 |
| 6 | 94 | 6 | 0 | 0 | 124 |
| 7 | 99.4 | 0 | 0.6 | 0 | 1,200 |
| 8 | 98.9 | 0 | 1.1 | 0 | 1,350 |
| 9 | 93.7 | 0 | 2 | 4.3*² | 1,466 |
| 10 | 99.4 | 0 | 0.6 | 0 | 82 |

*¹(a) + (b) + (c) + (d) = 100(parts)
*²N-vinylpyrrolidone which is a monomer having a hetero ring.

### Example 1

<Acrylic Resin and Production Example of Adhesive Containing the Same Resin>

The acrylic resin solution obtained in Polymerization Example 1 was used as a solution of an acrylic resin (1). To 100 parts of non-volatile components in the acrylic resin (1) was added 150 parts of ethyl acetate to obtain an ethyl acetate solution of acrylic resin composition having a non-volatile component content of 19.5%. To 100 parts of non-volatile components in the resulted solution was mixed 0.8 parts of a polyisocyanate-based compound (trade name: Takenate D-160N, manufactured by Mitsui-Takeda Chemical Inc.) and 0.4 parts of a silane-based compound (trade name: KBM-403, manufactured by Shin-Etsu Silicone) as a cross-linking agent, to obtain an adhesive of the present invention.

<Production Examples of Optical Laminated Film, and Optical Laminate>

Thus obtained adhesive was applied, using an applicator, on a releasing-treated surface of a polyethylene terephthalate film (manufactured by LINTEC Corporation, trade name: PET 3811) which had been subjected to releasing treatment so that the thickness after drying was 25 μm, the dried at 90° C. for 1 minute, to obtain an adhesive in the form of sheet. Then, a polarizing film (film having a three-layer structure obtained by adsorbing iodine into polyvinyl alcohol and stretching to obtain a stretched film and sandwiching said stretched film on both surfaces thereof by triacetylcellulose-based protective films) was used as an optical film, and a surface having the adhesive obtained above was applied on this optical film by a laminator, then, aged under a temperature of 23° C. and a humidity of 65% for 10 days, to obtain an optical laminated film having an adhesive layer. Subsequently, this optical laminated film was adhered on both surfaces of a glass base plate for liquid crystal cell (manufactured by Corning, 1737) so as to give Cross Nicol condition. This was preserved under 80° C. and dry condition for 96 hours (condition 1) and preserved under 60° C. and 90% RH for 96 hours (condition 2), and durability of the optical laminate and light leakage after preservation were observed visually. The results are classified as described below and shown in Table 2.

<Light Leakage Property of Optical Laminate>

Evaluation of state of generation of light leakage was conducted according to the following four stages.
⊚: no light leakage
◯: little light leakage
Δ: slight light leakage
x: remarkable light leakage
   <Durability of Optical Laminate>

Evaluation of durability was conducted according to the following four stages.
⊚: no change in appearance such as floating, peeling, foaming and the like
◯: little change in appearance such as floating, peeling, foaming and the like
Δ: slight change in appearance such as floating, peeling, foaming and the like
x: remarkable change in appearance such as floating, peeling, foaming and the like
   <Re-Working Property>

Evaluation of the re-working property was conducted as described below. First, the above-mentioned optical laminate was processed into a specimen of 25 mm×150 mm. Then, this specimen was pasted on a glass base plate for liquid crystal cell (manufactured by Nippon Sheet Glass Co. Ltd., Soda line glass) using a pasting apparatus (“Lamipacker”, manufactured by Fuji Plastic Machine K.K.), and treated in an autoclave under 50° C., 5 kg/cm² (490.3 kPa) for 20 minutes. Subsequently, the optical laminate for peeling test was heating under 70° C. for 2 hours and was preserved under 50° C. for 48 hours in an oven, and then, this pasted specimen was peeled toward 180° direction at a rate of 300 mm/min in an atmosphere of 23° C. and 50% RH, and the state of the surface of the glass plate classified according to the following conditions was observed and shown in Table 2.

Evaluation of the re-working property was conducted by observing the state of the surface of the glass plate according to the following four stages.
⊚: no fogging and past remaining on the surface of glass plate
◯: little fogging and the like on the surface of glass plate
Δ: fogging and the like on the surface of glass plate
x: paste remaining on the surface of glass plate

### Examples 2 to 8 and Comparative Examples 1 to 3

An acrylic resin composition, adhesive, optical laminated film and optical laminate were produced according to Example 1 using the acrylic resins (1) and (2) at weight ratios shown in Tables 2. Evaluation of the resulted optical laminate was conducted in the same manner as in Example 1, and the results are shown in Table 2 together with that of Example 1.

In Comparative Examples 1 and 2, an adhesive composed only of an acrylic resin (2), that is, an adhesive composed of an acrylic resin containing no structural unit (b) was used, and in Comparative Example 3, an adhesive composed of an acrylic resin (2) composition was used.

TABLE 2

| | | | | | | | | | | | Comparative | | |
|---|---|---|---|---|---|---|---|---|---|---|---|---|---|
| | | Example | | | | | | | | | Example | | |
| | | 1 | 2 | 3 | 4 | 5 | 6 | 7 | | 8 | 1 | 2 | 3 |
| Acrylic | Polymerization example | 1 | 2 | 3 | 3 | 4 | 5 | 5 | 2 | 6 | — | — | — |
| resin (1) | Non-volatile component | 100 | 100 | 30 | 30 | 30 | 30 | 30 | 70 | 30 | — | — | — |
| | content (part by weight) | | | | | | | | | | | | |

| | | | | | | | | | | | | | |
|---|---|---|---|---|---|---|---|---|---|---|---|---|---|
| Acrylic | Polymerization example | — | — | 7 | 8 | 7 | 7 | — | 7 | 7 | 9 | 10 | 7 |
| resin (2) | Non-volatile component | — | — | 70 | 70 | 70 | 70 | — | 70 | 100 | 100 | 30 | 70 |
| | content (part by weight) | | | | | | | | | | | | |

| | | | | | | | | | | | | |
|---|---|---|---|---|---|---|---|---|---|---|---|---|
| Condition 1 | Durability | ⊚ | ⊚ | ⊚ | ⊚ | ◯ | ◯ | ◯ | ⊚ | ◯ | ◯ | Δ |
| | Light leakage property | Δ | Δ | ◯ | ◯ | ◯ | ⊚ | ⊚ | ◯ | X | X | ◯ |
| Condition 2 | Durability | ⊚ | ⊚ | ⊚ | ⊚ | ⊚ | ⊚ | ⊚ | ◯ | Δ | ◯ | Δ |
| Re- | Paste remaining | ⊚ | ⊚ | ⊚ | ⊚ | ⊚ | ◯ | ◯ | ⊚ | ⊚ | ◯ | ⊚ |
| working | property | | | | | | | | | | | |
| property | | | | | | | | | | | | |

1. An acrylic resin (1) containing a structural unit derived from the following monomer (a) (structural unit (a), and a structural unit derived from the following monomer (b) (structural unit (b):
(a): a (meth)acrylate of the formula (A) 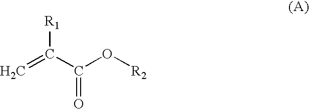
(wherein, R₁ represents a hydrogen atom or methyl group, R₂ represents an alkyl group having 1 to 14 carbon atoms or an aralkyl group having 1 to 14 carbon atoms, and a hydrogen atom in the alkyl group R₂ or a hydrogen atom in the aralkyl group R₂ may be substituted with an alkoxy group having 1 to 10 carbon atoms), and
(b): a monomer containing one olefinic double bond and at least one alicyclic structure in the molecule (the olefinic double bond contained in (b) may be contained in the alicyclic structure).

2. The acrylic resin (1) according to claim 1, wherein the content of the structural unit (a) is from 65 to 99.9 parts by weight based on 100 parts by weight of acrylic resin (1).

3. The acrylic resin (1) according to claim 1, wherein the content of the structural unit (b) is from 0.1 to 30 parts by weight based on 100 parts by weight of acrylic resin (1).

4. The acrylic resin (1) according to claim 1, wherein the structural unit (b) is a structural unit derived from isobornyl acrylate and/or cyclohexyl acrylate.

5. The acrylic resin (1) according to claim 1 further containing a structural unit derived from the following monomer (c) (structural unit (c)):
(c): a monomer different from the above-mentioned monomers (a) and (b), and containing one olefinic double bond and at least one polar functional group selected from the group consisting of a carboxyl group, hydroxyl group, amide group, amino group, epoxy group, aldehyde group and isocyanate group in the molecule.

6. An acrylic resin composition containing acrylic resin (1) according to claim 1 and the following acrylic resin (2):
acrylic resin (2): acrylic resin containing above-mentioned structural unit (a) and containing substantially no above-mentioned structural unit (b).

7. The acrylic resin composition according to claim 6 further containing a structural unit derived from above-mentioned monomer (c) (structural unit (c)).

8. The acrylic resin composition according to claim 6, wherein the content of the acrylic resin having lower molecular weight between acrylic resin (1) and acrylic resin (2) is from 5 to 50 parts by weight based on 100 parts by weight of the total amount of acrylic resin (1) and acrylic resin (2).

9. An adhesive comprising the acrylic resin (1) according to claim 1 or the acrylic resin composition according to claim 6, and a cross-linking agent and/or silane-based compound.

10. An optical laminated film obtained by laminating an adhesive layer composed of the adhesive according to claim 9 on both surfaces or one surface of an optical film.

11. The optical laminated film according to claim 10, wherein the optical film is a polarizing film and/or phase retardation film.

12. The optical laminated film according to claim 10, wherein the optical film is an optical film further having an acetylcellulose-based film as a protective film.

13. The optical laminated film according to claim 10, wherein a release film is further laminated on the adhesive layer of the optical laminated film.

14. An optical laminate obtained by laminating a glass base material on the adhesive layer of the optical laminated film according to claim 10.

15. An optical laminate obtained by peeling the release film from the optical laminated film according to claim 14, then, laminating a glass base material on the resulted adhesive layer of the optical laminated film.

16. An optical laminate obtained by peeling the optical laminated film from the optical laminated according to claim 14, then, laminating again the optical laminated film on the resulted glass base material.
